(19) United States
(12) Patent Application Publication
(10) Pub. No.: US 2004/0213388 A1
(43) Pub. Date: Oct. 28, 2004

(54) Correlation of electronic surveillance data and prison telephone calls

(76) Inventor: John Beck Mow, Frisco, TX (US)

Correspondence Address: John Beck Mow, 4665 Glen Heather Dr., Frisco, TX, 75034, US

(21) Appl. No.: 10/249,596

(22) Filed: Apr. 22, 2003

(51) Int. Cl. H04M 11/04; H04M 11/00

(52) U.S. Cl. 379/106.02; 379/38

(57) ABSTRACT

A computerized system and method of operation are disclosed that correlates electronic surveillance target data obtained from law enforcement agencies (LEA) against a database system of call detail information obtained from various sources such as prisons, to determine if there has been any communications between the two entities. Subsequently additional information such as call recordings of any matched conversations may be retrieved from the sources as requested by the LEA with ready access to language translators. The database call information will be further analyzed for patterns of activities or calling profiles of certain individuals with heuristic algorithms to aid the LEA in their detection and repression of illegal activities overall.

### BACKGROUND OF INVENTION

When a suspected criminal is captured and sent to a jail holding cell, their first telephone call may not be to their lawyer but rather to a crime partner. They learn quickly that they can place a call from inside any jail or prison to anybody they want to almost regardless of the restrictions imposed upon them.

Inmates sometimes get transferred to various city, county, private, State or Federal prisons. If a law enforcement-agency (LEA) investigator wants information about an inmate's telephone activities for a specified period of time, or if they want to determine which inmates from regional or national prisons have called a specific telephone number under electronic surveillance, they have to pursue this information one prison system at a time. This makes the investigator's job extremely tedious because there is no single access point to a database of all prisoner calls in this country. There are some standalone networks for large cities, counties, private prisons, State networks, and the Federal Bureau of Prisons, but these are not even interconnected to each other.

Virtually no prison system shares its telephone activities with any other prison regionally, statewide or nationally. Consequently for the approximately 2,000,000 inmates in the U.S. using about 200,000 inmate telephones from 5,000 prisons making over 500,000,000 completed calls a year, there are over 4,000 disparate, standalone prison telephone systems of various kinds and vintage. This makes it extremely time consuming and almost impossible for an investigator to track vital information of criminal and possible terrorist activities on a regional or wide scale.

Prior to the 1980's inmates were allowed to make telephone calls from prisons if a corrections officer or chaplain dialed the number and stood by listening to the inmate talk. Then private payphones were made available to inmates for collect calls to their families, friends and unknown parties and the number of calls escalated. As computer technology flourished using personal computers based upon operating systems such as DOS, QNX, and Windows, coupled with voice processing hardware to connect to telephone lines, a new form of Inmate Telephone System (ITS) was born. This new ITS offered many restrictions and controls that payphones could not and could provide integrated call recordings. U.S. Pat. No. 4,935,956, Automated Public Phone Control For Charge And Collect Billing, outlines a typical ITS system.

Criminals, however, discovered many holes in the payphones and ITS systems with 3-Way Calling being the feature where they could circumvent restrictions placed on their call destinations. 3-Way Calling is a standard feature on most home telephone services. Conference Calling accomplishes the same result of extending the prison call to another party while an approved call is in progress. It is a standard feature on Keysets, PBXs, central office services or 2-line telephones obtained at virtually any electronics store. With the advent of digital communication, relaying inmate calls anywhere can in many cases be accomplished silently with no detection methodology.

Although there are several patents claiming 3-Way Call detection, in practice inmates can make noises that mask the clicking or other sounds of many of the 3-Way features being activated by their friends or families whom they are allowed to call, and thus have their calls linked to virtually any telephone in world, continuing to run their criminal activities from behind bars at will. Other techniques are utilized to reach the destination of their choice, including “mugging” of other inmates to use their calling privileges. Many prisons have few if any controls on inmate calling because of the administrative hassles necessary to run a tight ship.

Most prisons or institutions contract with service providers to install and administrate the operations, billing and collections of the communications, but some prisons perform these functions themselves. The manufacturers of the ITS systems typically aggregate all call detail information from the prisons daily for technical and billing purposes. Depending upon the vintage of the ITS, call recordings may or may not be conducted. If recordings are made, they are usually kept at the prison ITS for local investigators to utilize online for 30-90 days, with long term archival storage in a different medium at the site. Recordings are normally not gathered by service providers due to the size of the records. However, they can be accessed via dial up modems requiring a few minutes download time per 15-minute call, or directly via IP links requiring a few seconds download time per call.

The Nation's communications networks are routinely used in the commission of serious criminal activities, including espionage. Organized crime groups and drug trafficking organizations rely heavily upon telecommunications to plan and execute their criminal activities.

The ability of law enforcement agencies to conduct lawful electronic surveillance of the communications of its criminal subjects represents one of the most important capabilities for acquiring evidence to prevent serious criminal behavior. Unlike evidence that can be subject to being discredited or impeached through allegations of misunderstanding or bias, electronic surveillance evidence provides jurors an opportunity to determine factual issues based upon a defendant's own words.

Applications for electronic surveillance must demonstrate probable cause and state with particularity and specificity: the offense(s) being committed, the telecommunications facility or place from which the subject's communications are to be intercepted, a description of the types of conversations to be intercepted, and the identities of the persons committing the offenses that are anticipated to be intercepted. Thus, criminal electronic surveillance laws focus on gathering hard evidence—not intelligence.

Electronic surveillance has been extremely effective in securing the conviction of more than 25,600 dangerous felons over the past 13 years as stated by the FBI in 2000. In many cases there is no substitute for electronic surveillance, as the evidence cannot be obtained through other traditional investigative techniques.

In 1999 the U.S. Office of the Inspector General performed a study of the Federal Bureau of Prisons. Their Executive Summary report is located at the following website: http.//www.usdoj.gov/oig/bopcalls/execsum.htm Some excerpts from it are:

“â•¦â•¦he talked on the telephone “all day long” and made arrangements for drug deals on the telephone almost every day, including participating in conference calls to Colombia”

“â•¦â•¦none of the facilities we visited had monitoring staff who were fluent in French, Russian, Chinese, or Arabicâ•¦”

“This special review conducted by the Office of the Inspector General (OIG) found that a significant number of federal inmates use prison telephones to commit serious crimes while incarcerated including murder, drug trafficking, and fraud.”

“Our interviews, case examinations, data collection, and document review paint a troubling picture of the scope and seriousness of inmate use of prison telephones to engage in criminal activity.”

Activities like these are being conducted all over the country by criminal inmates. Today's methods of correlating their activities takes weeks or months of effort, one prison at a time. Most investigations would never search more than a few prisons at a time. Furthermore there are no reports that show any regional, state or national studies or inmate calling profiles, much less correlating a half-billion calls a year to any electronic surveillance investigation.

Being able to determine if any incarcerated criminals are communicating with the target numbers of an electronic surveillance can not only pinpoint which inmate is calling, but if there is a recording of the conversation, providing even more hard evidence for the LEA. A national system could gather inmate recordings rapidly, in minutes or hours versus weeks by current methods, or not at all due to the enormity of the task of surveying over 4,000+disparate databases, which is more the case today.

### SUMMARY OF INVENTION

A national database of prison and other institutional call detail communications is created by establishing a communications link between the prisons, service providers or institutions (sources) of the call detail records and allows LEA officials to query the national database to determine if matches of their legally obtained electronic surveillance target data exist, showing which criminals or individuals in which prisons or institutions have communicated with the target numbers. Overall a virtual network comprised of some public and some private communication links is achieved providing access by LEA.

An important advantage of the system is that most if not all inmate call detail information in the country is stored in or accessed by one centralized system that can contain several year's information for tracking and classification purposes. Hard evidence recordings of matched calls can be obtained in a fast time frame of minutes or hours versus weeks by current methods or not at all which is more the case today.

In accordance with another aspect of the invention, foreign language translation of the communications can be readily achieved in an interactive manner with a translator. Furthermore having ready access to call details and determining patterns of this Nation's incarcerated criminal calling habits, provides a mechanism to perform many local, regional and national analyses and reports to assist LEA groups of this nation in reducing crime.

### BRIEF DESCRIPTION OF DRAWINGS

FIG. 1 is a System Diagram of the elements of the invention.

FIG. 2 is a process flow embodying the principles of the invention.

### DETAILED DESCRIPTION

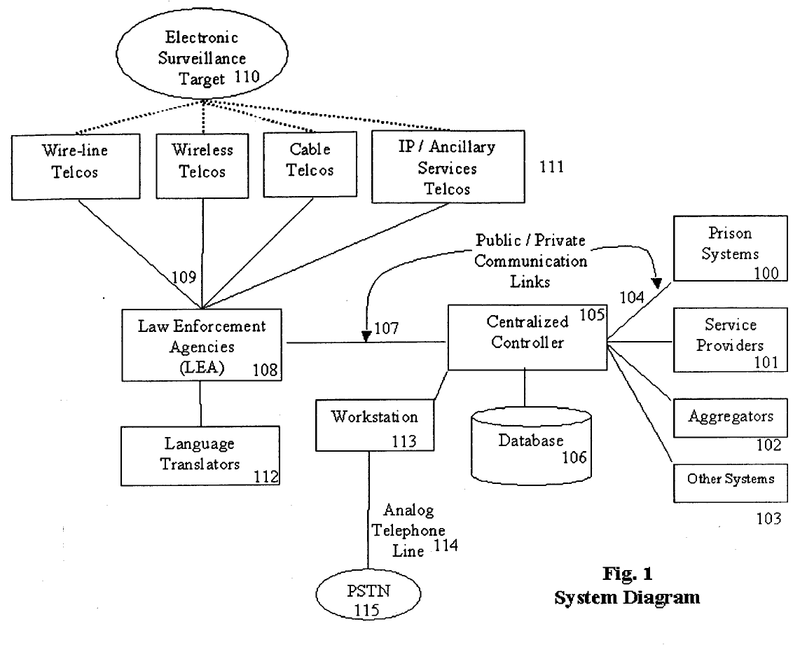

In FIG. 1, a Centralized Controller 105 comprised of microprocessor assemblies with large storage disk arrays and communication adaptors to the Internet, PSTN or private networks is constructed that is connected to a plurality of Law Enforcement Agencies (LEA) 108 via public or private communication links 107, and to a plurality of call detail sources being Prisons 100, Service Providers 101, Aggregators 102, or Other Systems 103, via public or private communication links 104. Other Systems 103 may represent a PBX, payphone services, Key Systems or such that can generate call detail information.

The LEA 108 allows Language Translators 111 to be connected as necessary if a recording is received that needs translation and is connected via temporary communication links 109 to the applicable telephone company 111 which performs the electronic surveillance of the target 110 under court orders and strict guidelines.

A workstation 113 of the system is connected to an analog PSTN 115 telephone line 114 for remote LEA or translator access to have a recorded call audibly played back to them or for remote access to the system for verbal query commands and responses.

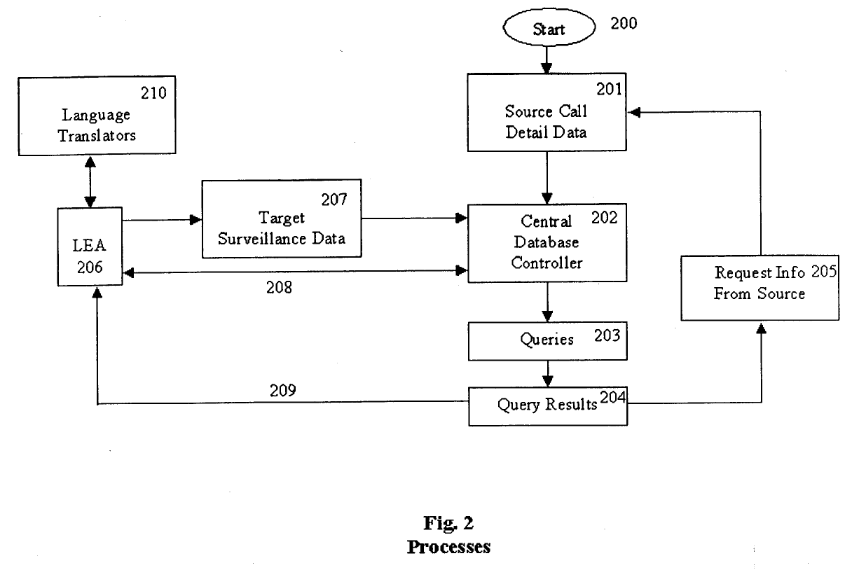

The Start 200 of FIG. 2 obtains a history of call detail data from a plurality of sources 201 loaded into or accessible to the Central Controller's 202 database. When a LEA 206 desires to perform a query of a target's electronic surveillance data 207 which may be one or multiple telephone target numbers and/or all of the called-to or called-by numbers of the targets, the query 203 is executed. The query results 204 showing any matches between the entities, are forwarded 209 back to the LEA. If there is a request for additional information 205 such as a call recording, it is requested of the originating source 201 verbally or electronically. The source may provide access directly from the Central Controller 202 to the prison ITS or may perform the access themselves via a verbal request from the Central Controller customer service personnel. Once received, the recording(s) are stored at Central 202 and then forwarded to the LEA 206 via a communication link 208. If a language translation is required, the translators 210 are given access to the information electronically or may request that the recording be played to them audibly over a telephone connection.

The flow process continues with automated stored queries 203 being performed as new source data 201 arrives periodically. Automated reports and alerts are issued as determined by the query results 204 back to the LEA 206.

The foregoing description uses preferred embodiments and processes to illustrate the present invention but is not limited to these embodiments. Modifications may be made by those skilled in the art which differ from the specific details disclosed here, but which are still within the scope of the invention.

What I claim is:

1. A method of correlating data in a central computer server system connected to communications resources comprising:
means of obtaining telephone call detail records (CDR) from a plurality of sources;
means for formatting received CDR into a common database format;
means for accessing a remote source CDR database conditioned on the records being maintained at a source;
means of obtaining electronic surveillance data of a target under investigation from a plurality of law enforcement agencies (LEA);
means for providing access by the LEA to electronically or verbally perform queries of the CDR;
means for determining if there is one or more matches in the CDR database of the LEA target telephone number, which may include called-to and called-by telephone numbers;
means for reporting the results of the query back to the LEA in a variety of communication methods including messaging, visual mapping or in audible form.

2. Means in accordance with claim 1 wherein said system includes:
means for retrieving the digital call recording(s) of the matched target number from the sources upon receiving a request from the LEA;
means for allowing audible play back of the recordings through a workstation connected to the central system and an analog interface to a PSTN telephone line upon a request by the LEA.

3. Means in accordance with claim 1 wherein said system includes:
means for providing the call recording(s) to foreign language translators;
means for storing multiple target data for a period of time automatically performing a query whenever new source data is received;
means for communicating back to the sources to block telephone calls or perform certain events based upon LEA input or thresholds exceeded.
